(19) United States
(12) Patent Application Publication
(10) Pub. No.: US 2015/0066644 A1
(43) Pub. Date: Mar. 5, 2015

(54) AUTOMATED TARGETING OF INFORMATION TO AN APPLICATION USER BASED ON RETARGETING AND UTILIZING EMAIL MARKETING

(71) Applicant: Staples, Inc., Framingham, MA (US)

(72) Inventors: Ashok Narasimhan, Los Altos Hills, CA (US); Amit Rathore, Burlingame, CA (US)

(21) Appl. No.: 14/479,359

(22) Filed: Sep. 7, 2014

Related U.S. Application Data
(63) Continuation-in-part of application No. 12/843,360, filed on Jul. 26, 2010.
(60) Provisional application No. 61/875,006, filed on Sep. 7, 2013.
(60) Provisional application No. 61/875,007, filed on Sep. 7, 2013.
(60) Provisional application No. 61/273,056, filed on Jul. 30, 2009.

(51) Int. Cl. G06Q 30/02

(52) U.S. Cl. CPC G06Q 30/0255; G06Q 30/0269
USPC 705/14.53

(57) ABSTRACT

In one example implementation, behavioral data describing past actions including products viewed and purchases made by users while visiting applications is compiled. The behavioral data is segmented into clusters of behavior factors according to statistically related actions of the users. An electronic address for the user is received from a computer of the user. The electronic address is then processed for user data profiling the user. A match between the user data profiling the user and one of the clusters of behavior factors is computed. Targeted information is generated based on the match. The targeted information is provided to the computer of the user for presentation.

### CROSS REFERENCE TO RELATED APPLICATIONS

This application is a continuation-in-part of U.S. patent application Ser. No. 12/843,360, entitled “Automated Targeting of Information to a Website Visitor” and filed Jul. 26, 2010, which claims the benefit under 35 U.S.C. §119(e) of U.S. Provisional Patent Application No. 61/273,056, filed Jul. 30, 2009, the entire contents of each of which are incorporated herein by reference. This application also claims the benefit under 35 U.S.C. §119(e) of U.S. Provisional Patent Application No. 61/875,006, entitled “Automated Targeting of Information to a Website User Utilizing Email Marketing” and filed Sep. 7, 2013, and U.S. Provisional Patent Application No. 61/875,007, entitled “Automated Targeting of Information to a Website User Based on Retargeting” and filed Sep. 7, 2013, the entire contents of each of which are incorporated herein by reference.

### FIELD OF THE DESCRIBED EMBODIMENTS

The described embodiments relate generally to providing information to a potential customer. More particularly, the described embodiments relate, in some cases, to providing automated targeted information to a user while using an application.

### SUMMARY

According to one innovative aspect of the subject matter described in this disclosure, a system includes one or more processors and one or more memories storing instructions that, when executed by the one or more processors, cause the system to, compile behavioral data describing past actions including products viewed and purchases made by users while visiting applications; segment the behavioral data into clusters of behavior factors according to statistically related actions of the user; receive an electronic address for the user from a computer of the user; process the electronic address for user data profiling the user; compute a match between the user data profiling the user and one of the clusters of behavior factors; responsive to computing the match, generate based on the match targeted information associated with a merchant application; and provide the targeted information to the computer of the user for presentation.

In general, another innovative aspect of the subject matter described in this disclosure may be embodied in methods that include compiling with a server coupled to a computer network behavioral data describing past actions including products viewed and purchases made by users while visiting applications hosted by servers accessible by the users via the computer network; segmenting with the server the behavioral data into clusters of behavior factors according to statistically related actions of the users; receiving by the server an electronic address for the user from a computer of the user; processing with the server the electronic address for user data profiling the user; computing with the server a match between the user data profiling the user and one of the clusters of behavior factors; responsive to computing the match, generating with the server based on the match targeted information associated with a merchant application; and providing by the server the targeted information to the computer of the user for presentation.

Other implementations of one or more of these aspects include corresponding systems, apparatus, and computer programs, configured to perform the actions of the methods, encoded on computer storage devices.

These and other implementations may each optionally include one or more of the following features, such as that parsing with the server a business name from the email address; inferring with the server a business type from the business name; processing with the server a log-in request received from the computer of the user; determining with the server an IP address associated with the computer; determining with the server a geographical location associated with the user; determining with the server a business location for the business name; confirming with the server the geographical location matches the business location; that identifying with the server one or more products related to the business type, the one or more products offered for sale via an application accessible via the computer network; including with the server the one or more products in the targeted information; applying natural language to the email address to determine the user data profiling the user; that the electronic address is a business email address associated with the user; and delivering by the server coupled to the computer network the targeted information in an email to the user.

In general, yet another innovative aspect of the subject matter described in this disclosure, a system includes one or more processors and one or more memories storing instructions that, when executed by the one or more processors, cause the system to, compile behavioral data describing past actions including products viewed and purchases made by users while visiting applications; segment the behavioral data into clusters of behavior factors according to statistically related actions of the user; compile present user data describing a current action of a user while visiting a merchant application; compute a match between the user data profiling the user and one of the clusters of behavior factors; responsive to computing the match, generate based on the match targeted information associated with a merchant application; receive an indication that the user has left the merchant application; and retarget the user by transmitting the targeted information for display to the user as an advertisement via another application being used by the user.

These and other implementations may each optionally include one or more of the following features, such as that receiving tracking information identifying the user's online location; providing the targeting information to an ad server associated with the online location for display to the user as the advertisement; that providing the targeting information to a web advertising exchange to present the targeted information to the user while the user is web browsing; that compiling the behavioral data includes receiving with user click-through data describing click-throughs performed by the user while viewing content via the applications; and retargeting the user includes determining information included within the content viewed and influencing the targeted information based on one or more of the click-throughs and the content viewed.

It should be understood that the language used in the present disclosure has been principally selected for readability and instructional purposes, and not to limit the scope of the subject matter disclosed herein.

### BACKGROUND

Online shopping is continually increasing in popularity and has evolved with the growth in technology. Many consumers visit online shopping websites to compare product features and their prices. However, the percentage of online consumers who actually buy a product after viewing it online is very low. An online consumer is mainly influenced by the sales price offered for a particular product. In cases where the sales price offered is appropriate, the online consumer will end up buying the product online.

In order to efficiently use the consumer behavior data, a number of price optimization techniques have been developed. The techniques consider various consumer behavior factors such as time spent on a website, type of products browsed, etc., to provide a consumer with an incentivized pricing scheme. However, most of the price optimization techniques suffer from one or more limitations.

One limitation of existing price optimization techniques is the low conversion ratio of consumers visiting the website to consumers making an online purchase through the website. Further, another limitation of the existing price optimization techniques is to monitor consumer behavior on a large scale across a large number of websites and merchant types. Monitoring consumer behavior on a large scale requires deployment of an extensive hardware and software infrastructure.

There is a need for a method, and a system for optimizing information provided to different consumers based on the stage of the product purchase cycle a consumer is in. Further, there exists a need for providing an optimum pricing mechanism for a merchant that is based on present consumer behavior and predetermined past customer behavior

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 shows an example of system for collecting and analyzing behavioral data of a plurality of users from a plurality of applications (e.g., websites).

FIG. 2 shows an example of system for matching the present user data with at least one of the different clusters of behavior factors, and while the present user is still visiting the present application (e.g., website), generating and displaying targeted information to the present user.

FIG. 3 is a flow chart that includes an example method of targeting information to a user while using an application.

FIG. 4 is a flow chart that includes steps of a method of providing real-time targeted information to a consumer.

FIG. 5 is a flow chart that includes an example method of providing real-time targeted economic value information to a consumer.

FIG. 6 shows a computing architecture in which the described embodiments can be implemented.

### DETAILED DESCRIPTION

The embodiments described include methods and apparatuses for providing automated, real-time information targeted to a website visitor. In some embodiments, this includes providing price discounts in real time based on consumer characteristics to increase the conversion ratio of online consumers visiting a merchant's application to online consumers making a purchase on the application.

Typically, online consumers leave a merchant's application after viewing the product details page. Some consumers may add a product to their shopping cart, but later discontinue the purchase of the product in the shopping cart. However, a consumer who has added a product to the shopping cart is more likely to purchase the product than the consumer who has simply viewed the product details page. Such consumer behavioral data of those who added a product to their shopping cart, if collected, can be used for various purposes such as setting the sale price or offering discounts on the sale price of a product.

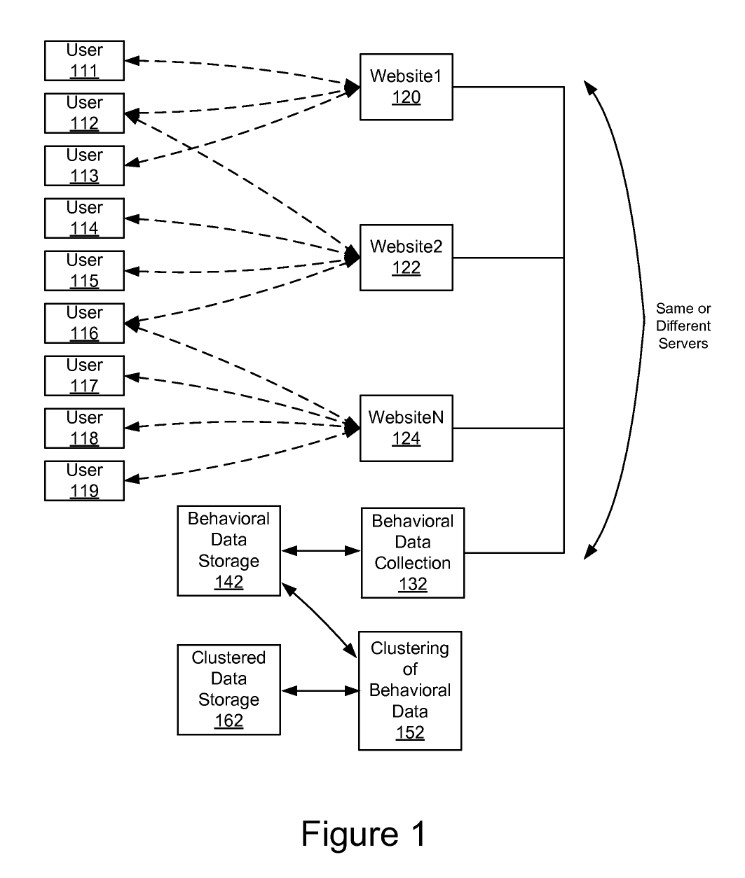

FIG. 1 shows an example of system for collecting and analyzing behavioral data of users from a plurality of applications, such as websites, although other variations are possible where an application's acts, structure, and/or functionality is distributed between an application operating natively on a user's computer and an application hosted by a server coupled to a computer network. As shown, exemplary users 111-119 visit websites 120, 122, 124. The actions of the users 111-119 as they visit the websites 120, 122, 124 can be monitored and collected. More specifically, behavioral data of the users 111-119 can be collected from the websites 120, 122, 124 by monitoring the websites 120, 122, 124 and collecting the data about the users. The users 111-119 include computing devices coupled to a computer network, to which the websites 120, 122, and 124, and server 132 and 152 are also coupled. The network may include any computer network across which computing devices may communicate and interact, such as public and private networks, virtual networks, etc.

As shown, a server 132 collects the behavior data which is then stored (storage 142).

The storage 142 or storage 162 may be a non-transitory storage device that stores data. For example, the storage 142 or storage 162 may include a dynamic random access memory (DRAM) device, a static random access memory (SRAM) device, flash memory, and/or some other memory device. In some implementations, the storage 142 or storage 162 includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, and/or some other non-volatile storage device.

In some embodiments, the collected data may include actions of the visiting users before arriving at the merchant application, actions taken on the merchant application such as which pages were viewed in what order, products placed into a shopping cart, purchases subsequently made by the visiting users, etc. For instance, the collected behavior data includes past actions including products viewed and purchases made by users while using applications. The collected data can include, for example, pre-click information, checkout status, and/or post-click information. A non-exhaustive exemplary list of pre-click information includes a referral URL (Universal Resource Locator), search (such as, search, number of search terms, specific search terms, specific search phrases), banner advertisements (such as, advertisement context, referrer domain, second referrer domain), comparison engine (such as, number of search terms, specific search terms, specific search phrases, comparison page context, customer entered zip code), referrer domain, referrer page contents (such as, shopping comparison site), customer information (such as, return customer, characterizing history data), customer location (such as, time zone, location, demographics, weather, merchant shipping costs). A non-exhaustive exemplary list of check out status includes adding to cart, viewing cart, and/or checkout. A non-exhaustive exemplary list of post-click information includes path/actions through site, products viewed, browsing pattern, time on site, cart contents (such as, products, product groups, value, abandonment), current location in funnel, day of week, special day and/or price modifications already applied.

In some embodiments, the collected data may include present user data, which is data collected in real-time (e.g., contemporaneously with a user's use of an application, such as a website, etc.) describing a current action of a user while using a merchant application, the current action includes the user adding a product to a virtual shopping cart of the merchant application. For instance, the present user data may include one or more user actions reflecting a user's behavior in interacting with the application.

A server 152 analyzes the collected behavior data. The analyzing can include clustering the collected behavioral data, which in some embodiments, includes segmenting the collected behavioral data into clusters of behavior factors according to statistically related actions of the users. The segmented behavior factors can be used to predict future behavior of the users. The clustered collected behavioral data can be stored in clustered data storage 162 for future access.

For example, the collected behavioral data may indicate, through statistical analysis, that visiting users who view certain pages of a website, such as those describing a tennis racket, are more likely to purchase certain products (such as tennis balls) if offered at a certain discount, than those who do not view those pages.

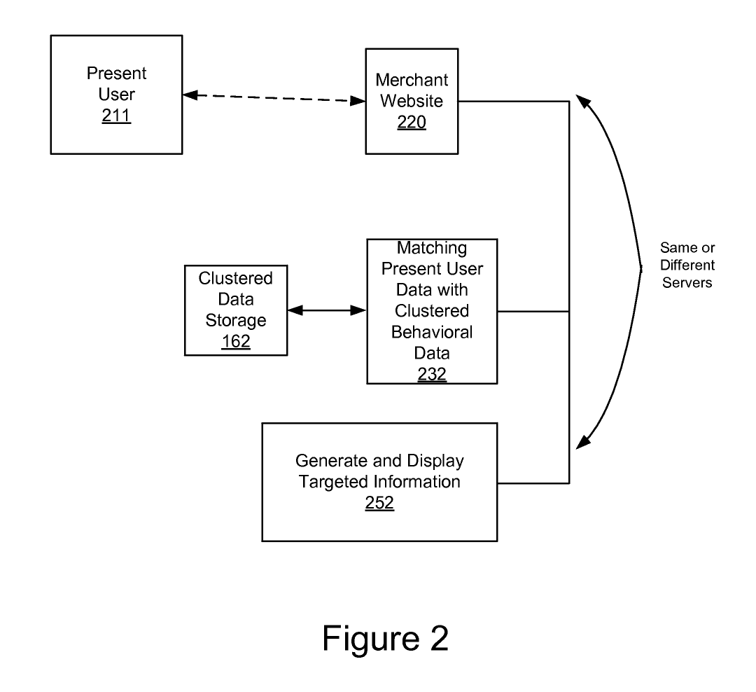

FIG. 2 shows an example system for matching the present user data with at least one of the clusters of behavior factors, and while the present user is still visiting the present application (e.g., website), generating and displaying targeted information to the present user. A present user 211 accesses a merchant website 220. A server 232 executes a matching of the present user data with at least one of the clusters of behavior factors.

It should be understood that the servers 132, 152, 232, and 252, and the servers hosting the websites 120, 122, 124, and 220, as shown and described, may be the same server, the same group of servers, common/shared servers, distinct servers (coupled via a network for communication), a combination of the foregoing, etc. Moreover, the use of the term server is not limited to a single virtual, software, and/or hardware server but may include two or more such servers depending on the embodiment.

In some embodiments, the matching is based on a comparative analysis of the present user data with the clustered behavior factors of the clustered database stored in the storage 162. In some embodiments, the comparative analysis includes identifying correlations between the present user data and each of the clustered behavior factors, and identifying which of the clustered behavior factor is most correlated to the present user data, thereby identifying a match between the present user data and the at least one cluster of behavior factors. In a non-limiting example, a match includes using one of the clusters of behavior factors from the collected behavioral data of the users that have used the merchant application previously and using one of the clusters of behavior factors for finding a corresponding relationship to the present user data of the user while using the merchant application. For example, the behavioral data collected from the users may include content reviewed by the users across many applications. The content reviewed may include but is not limited to, a car blog on the merchant application and/or search terms such as (Ford, V8 engine, tires, etc.) entered by the users. In some embodiments, the collected behavioral data is segmented by the server 152 into clusters of behavior factors that contain similar behaviors (pages browsed, search terms, etc.) of the users. In some embodiments, the present user data may include similar pages browsed, search terms entered (American cars, V8 engine, summer tires, etc.) and blogs visited on the merchant application. Using the present user data and one of the clusters of behavior factors the server 232 computes the match by comparing the present user data with one of the clusters of behavior factors collected and upon a successful correlation, the server 252 will provide targeted information (ads, recommended products, etc.) to the present user. Numerous other variations are also possible and contemplated.

Some embodiments include the present user loading pages from the application that describe tennis rackets. Contemporaneous to the load, the server 232 collects data describing the pages being loaded on the application and matches one or more characteristics of the pages (products included in the pages), to one or more clusters of behavior factors in the clustered behavioral data of server 232 and clustered database stored in the storage 162. In some embodiments, the stored clustered behavioral data may include clusters that describe the present user as a certain shopper such as one that purchases products associated with a specific category (e.g. gardening, sports, home appliances, furniture) and/or purchases products (e.g., tennis balls) that are discounted.

In some embodiments, for example, the match may include identifying with the server 232 a corresponding relationship between the products browsed by the user on the pages and one of the clusters of behavior factors associated with the user, which in return may include identifying the present user as likely to purchase the product (e.g., tennis balls) if offered at a certain discount. The process of matching data occurs in an elapsed time short enough such that actions subsequently motivated by the match can be made without the present user being aware that such time has elapsed and before the present user can perform another action, such as leaving the application (e.g., merchant website).

Existing methods of matching user data to behavioral segments cannot effect the match in a manner timely enough not to be noticed by users or to allow the system to take actions to affect user behavior before the user takes actions that preclude it, such as leaving the application.

A server 252 provides targeted information (e.g., a price discount for an in-cart product) based upon the matching.

For example, the completed match for present users who view pages describing tennis rackets may indicate that these users should be offered a discount on tennis balls, and further, that such discount should be of a particular size (amount) to optimize the overall profit gained by the merchant.

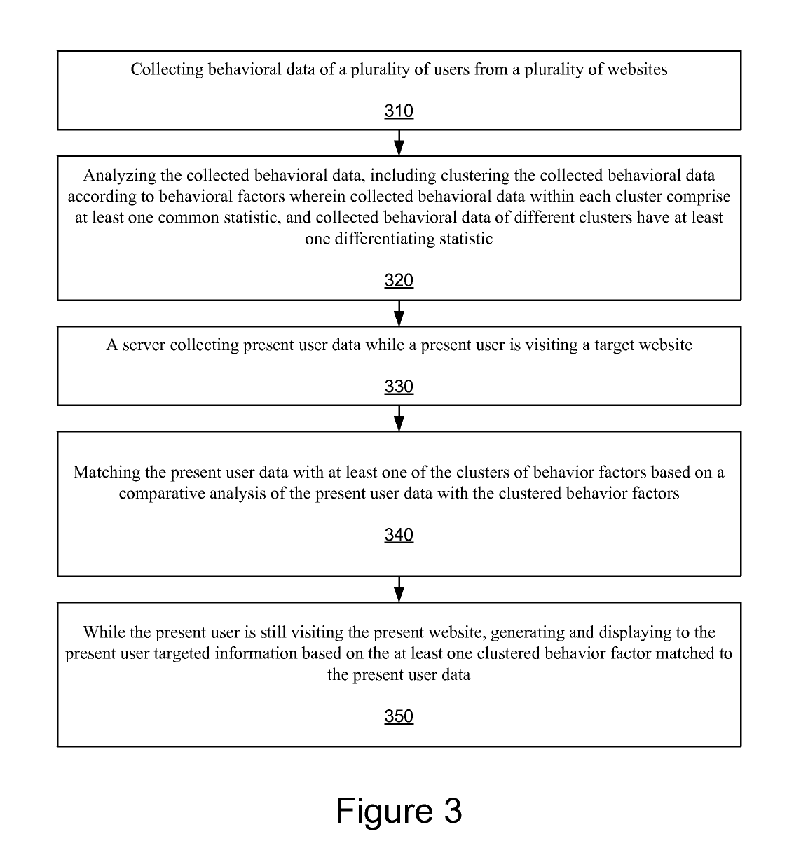

FIG. 3 is a flow chart that includes steps of an example method of targeting information to a user while using an application. A first step 310 includes collecting behavioral data of users from a plurality of applications. A second step 320 includes analyzing the collected behavioral data, including clustering the collected behavioral data according to behavioral factors. The collected behavioral data within each cluster may include at least one common statistic, and collected behavioral data of different clusters have at least one differentiating statistic. A non-limiting example of a common statistic within each cluster may include products of the same manufacture and a category browsed by users while using the application, while a differentiating statistic within each cluster may include products of the same category (tires, etc.) but different manufactures (Michelin, Bridgestone, Toyo, etc.). A third step 330 includes a server 232 collecting present user data while a present user is visiting a target application (e.g., website, native app, etc.). A fourth step 340 includes the server 232 matching the present user data with at least one of the clusters of behavior factors based on a comparative analysis of the present user data with the clustered behavior factors. A fifth step 350 includes while the present user is still visiting the present application, generating and displaying to the present user targeted information (via the server 252 and/or the computer of the present user) based on the at least one clustered behavior factor matched to the present user data.

### Email Marketing

Some embodiments include influencing information included within the targeted information based on analysis of an email address of the user. Some embodiments further include delivering the targeted information to the user through an email to the user.

As an example, some embodiments may include receiving by the server 232 an electronic address for the user from a computer of the user. For example, the electronic address may include an email address associated with the user. As further non-limiting example, the email address may be a business email address associated with the user. The server 232 may process the electronic address for user data profiling the user. In some embodiments, the server 232 may be configured to process the electronic address for user data profiling the user by applying natural language to the email address to determine the user data profiling the user. For instance, the server 232 may parse a user's name, a business name, and/or other descriptor, from the email address. As a further example, for the example email address admin@sanmateodental.com, the server 232 may parse (e.g., using delimiters) “sanmateodental” and then infer, using natural language, that “sanmateodental” represents “San Mateo Dental.” The server 232 may then perform a lookup using a business directory database and the name “San Mateo Dental” to match the name to a known business. In some further embodiments, the server 232 may infer a business type from the business name. For instance, from the word “dental,” the server 232 may determine that the email address is associated with a dental office. To make this determination, the server 232 may query a database storing a map of terms with business types (e.g., dental and dental office).

The server 232 may be configured to determine the geo-location of the user, for instance, based on location information received from a computer of the user (e.g., the user's mobile device), a cellular server, the server 232 itself, another component of a computer network, etc. For instance, the server 232 may determine an IP address associated with the computer of the user and determine a geographical location associated with the user. In a further example, a server (e.g., a website server, server 232, another server described herein, etc.) may be configured to process a log-in request received from the computer of the user via the computer network. For instance, the merchant application may require a user (e.g., a registered user) to log-in to purchase products and/or access his/her account on the merchant application. This may be done by receiving a log-in request from the user's computer. In response, the server 232 may determine the user's geographical location. This may be done using location data received from the user's computer, included in a request, from the user's user profile, etc. In an example, the server 232 may determine the user's IP address (e.g., from the HTTP data received from the user's computer) and determine a geographical location associated with the user based on the IP address (e.g., by performing a look-up using an IP lookup service), although numerous other variations are also possible, such as using GPS coordinates of the user's computer to determine the user's location, etc.

In some embodiments, the server 252 may be configured to identify one or more products related to the business type. A non-limiting example of the business type may include a service business, a merchandising business, manufacturing business, and/or hybrid business. This is advantageous as it can identify products that are more relevant to the user associate with the business type and that the user is more likely to purchase. The server 252 may also include the one or more products in the targeted information.

In some embodiments, the server 232 may be configured to determine a business location for the business name. The server 232 may also confirm the geographical location matches the business location. For instance, if the email is admin@sanmateodental.com, the algorithms discussed herein may determine that this is the office manager from a dentist's office, and that it is located in San Mateo, Calif. For instance, the server 252 may be configured to use the geolocation of the user's computer and the user data, as determined by server 232, to determine the business name and geographic location (e.g., by querying a business directory stored in a non-transitory data store using the user's geolocation (e.g., IP address of the logged in user) and the user's user data), although numerous other suitable variations are also possible. As discussed elsewhere herein, in some embodiments, the analysis of the email address may include applying natural language to the email address to determine additional information about the user, and using the additional information to influence the targeted information.

The server 252 may incorporate one or more products related to the business and provide the one or more products in the targeted information to the user. For instance, in the above example, the user may be targeted with items that a dentist office might need to buy. The products may be stored in a product database stored in a non-transitory data store. The server 252 may deliver the targeted information to the user, for instance, in an email, via a website, via a mobile app, push notification, etc. For instance, the products may be offered for sale to the user via an application, such as a merchant website, accessible via the computer network.

### Retargeting

Some embodiments further include providing the targeted information to the user through retargeting. For instance, this may be comparable to ad networks and ad exchanges used for behavioral targeting. However, instead of showing a regular ad, the system shows the targeted information. In some embodiments, the retargeting includes utilizing a web advertising exchange to present the targeted information to the user while the user is web browsing or utilizing a mobile or native app.

In some embodiments, the server 232 may be configured to receive an indication that the user has left the merchant application. The indication may include a signal (e.g., http request) received from an application (e.g., web browser) received from the user's computer, a cookie from a third-party server that tracks the user's visits to various applications, usage information from the user's computer tracking the user's application usage habits, or other suitable means. In a further example, a cookie may use a random ID number that can be associated to the user and generate a profile of the applications visited (e.g. music sites, car sites, etc.) by the user. The profile can then be used to provide with the server 252 targeted information to the user by matching the ID number to the user.

As a further example, tracking the user's activity throughout different applications can be done by using multiple cookies form multiple third party servers, where the merchant application receives cookie information and retargets and transmits the targeted information to the user. In some embodiments, the servers 132 and/or 232 may be configured to receive tracking information identifying the user's online location. For example, the tracking information may be provided by cookies of third party servers imbedded on the merchant application.

The server 252 may retarget the user by transmitting the targeted information for display to the user as an advertisement via another application being used by the user. In some embodiments, the server 252 may retarget by determining information included within the content viewed and influencing with the server 252 the targeted information based on one or more of click-throughs and the content viewed. In some instances, the server 132 may receive user click-through data from an analytics data store, one or more analytics servers coupled to the network, etc., that describes click-throughs performed by the user while viewing content via the applications hosted by the server 132.

As a further non-limiting example, the server 232 may influence the targeted information based on one or more click-throughs executed by the user during the retargeting. In some embodiments, this includes the use of data and predictive models in the system to “reconvert” the shopper into a buyer since the system has data about the pre and post click. In some embodiments, the targeted information is influenced by the click-throughs executed by the user, and by website information of websites in which the user clicked-through from. For instance, this would differentiate the experience of the user depending on if they clicked through the targeted information from a website like Wall Street Journal or People Magazine.

In some embodiments, the server 252 may provide the targeted information to an ad server associated with the online location for display to the user as the advertisement.

In some embodiments, the server 252 may be configured to provide via a computer network (e.g., a public, private, and/or virtual network) the targeted information to a web advertising exchange to present the targeted information to the user while the user is web browsing. In some embodiments, the server 132 may compile the behavioral data as discussed elsewhere herein.

In some embodiments, collecting behavioral data of users from a plurality of applications includes monitoring merchant applications and collecting data about users that visit the merchant application. For example, the applications used by the users may monitor user actions while using various applications (e.g., websites, native apps, etc.) associated with various merchants or other service providers and transmit that data to the servers 132, 152, etc. for collection, storage, and clustering thereby. The user actions may, in some examples, reflect products viewed and purchases made by users while using the applications. By way of further example, the collected data includes actions of the visiting users before arriving at the merchant application, actions taken on the merchant application such as which pages were viewed in what order and any products placed into a virtual shopping cart and purchases subsequently made by the visiting users.

In some embodiments, clustering the collected behavioral data includes segmenting the collected behavioral data into behavior factors according to statistically related actions of the users, where the segmented behavior factors can be used to predict future behavior of the users.

In some embodiments, compiling behavioral data of a user while using a merchant application includes, monitoring the merchant application and compiling present user data describing a current action of the user while using the merchant application. For example, the current action includes the user adding a product to a virtual shopping cart of the merchant application.

In some embodiments, while the user is still using the merchant application, includes performing a comparative analysis including determining a match between the present user data and a cluster from the clusters of behavior factors and generating a demand function based on the match and the business rules associated with the merchant application.

In some embodiments, the comparative analysis includes determining a match between the present user data and a cluster from the clusters of behavior factors and generating a demand function based on the match and the business rules associated with the merchant application.

For example, in some embodiments, the comparative analysis of the present user data with the clustered behavior factors includes identifying correlations between the present user data and each of the clustered behavior factors, and identifying which of the clustered behavior factor is most correlated to the present user data, thereby identifying a match between the present user data and the at least one cluster of behavior factors. The identified correlation can include, for example, at least one of timing of user actions, and history of the user. The timing of user actions can include, for example, at least one of timing of elapsed time between the user's appearance on the present application and first carting, or timing between visits by the user to the present application. The history of the user can include at least one of information of whether the user was directed to the present application through a search service, whether the user was directed to the present application through a comparison shopping service, the user's order of pages browsed, search terms used by the user to arrive at the present application, attributes of a referring application.

In some embodiments, the identified correlations include at least one of a computer type (for example, Macintosh® versus PC) of the user, an operating system type (such as, Windows® versus Unix) of the user, a browser type of the user (for example, Explorer® versus Netscape), or a location (for example, latitude and longitude) of the user.

In some embodiments, the match is between the present user data and a precompiled cluster of behavior factors. In some embodiments, generating targeted information based on the comparative analysis includes a discount for the product in the virtual shopping cart. In some embodiments, the targeted information including the discount for the product in the virtual shopping cart is provided to the user before the user leaves the merchant application. This particular point in the user's application visit can be a particularly opportune time to offer, for example, the discount that will prompt a transaction to actually occur.

In some embodiments, the targeted information is additionally based on product information of competitive merchant products. The product information can be obtained, for example, by determining past search terms used by the present user, running a real-time search during the present user's session, determining competitive merchants based on search results of the real-time search. By analyzing the prices offered by the competitors, a comparative analysis of the prices offered by all the players, including the competitors and the merchant can be performed. Typically, a consumer is directed to a merchant's webpage through a search engine. The search terms are included in the referral URL, which has directed the consumer to the merchant's webpage. Search terms used by the consumer can be identified based on the URL parameters in the merchant's webpage passed on by the search engine. Those search terms can be entered at the search application to download the search results page, and store the results for an offline analysis.

During an offline analysis, pricing of similar products offered by competitors, which have been provided by the search engine, are identified. Competitor data can be aggregated in search results such as the price data of the competitor products, or merchant data listed in the search results page. The competitor data is related with the consumer's behavior on the merchant's application. A “quality score” for the search results page produced can be calculated from search terms. The quality score is determined by ascertaining a Click Through Rate (CTR) of a user on the merchant's application among the search results. CTR is obtained by dividing the number of users who clicked on a link by the number of times the link was delivered. A server can then provide feedback to the merchant on the performance of activities in search engine optimization and Search Engine Marketing (SEM) such as buying keywords from SEM vendors such as Google® AdWords, Yahoo!® Search Marketing and Microsoft® adCenter. Search engine optimization is a process of enhancing the volume of web-traffic from a search engine to a merchant's site. Competitors' product prices can be compared to the merchant's product prices. This analytic data can be provided to the merchant for price optimization.

Some embodiments include collecting (obtaining) additional information of a customer by using a JavaScript program on the merchant application. The JavaScript program in real time identifies the consumer based on the cookies in the consumer's browser, and the program stores a real-time feed of the consumer's behavior.

First-party cookies can be dropped by the merchant's website onto the consumer's browser, which may be used for tracking the consumer across all of the merchants serviced by the automated price optimization service. When a consumer visits a merchant's application, the JavaScript program opens a first IFrame within the merchant's webpage. The first IFrame corresponds to a web page hosted on a server. The first IFrame searches for a first-party cookie belonging to the server and including identification information of a consumer. If the consumer is new and no earlier first-party cookie is identified, a new first-party cookie is dropped on the consumer's browser. The first IFrame then launches a second hidden IFrame hosted on the merchant's server. The consumer identification information is passed on to the second IFrame as parameters within the Uniform Resource Locator (URL) of the second hidden IFrame. The second hidden IFrame then stores the consumer identification information in a new or existing first-party cookie corresponding to the merchant's application. Thereafter, the consumer identification information is passed from a cookie corresponding to a cookie corresponding to any other merchants' application. Therefore, the consumer is tracked on any merchant's application, even if the consumer has disabled or blocked third-party cookies on his/her browser.

The JavaScript program also gathers consumer behavioral information, such as shopping data before purchase and after purchase, prices offered, and purchase history, and stores it in database for an offline analysis. Consumers are identified by using cookies on their browsers. The JavaScript program runs on the web pages of all the merchants. This helps in gathering consumer behavioral information from multiple merchants' applications.

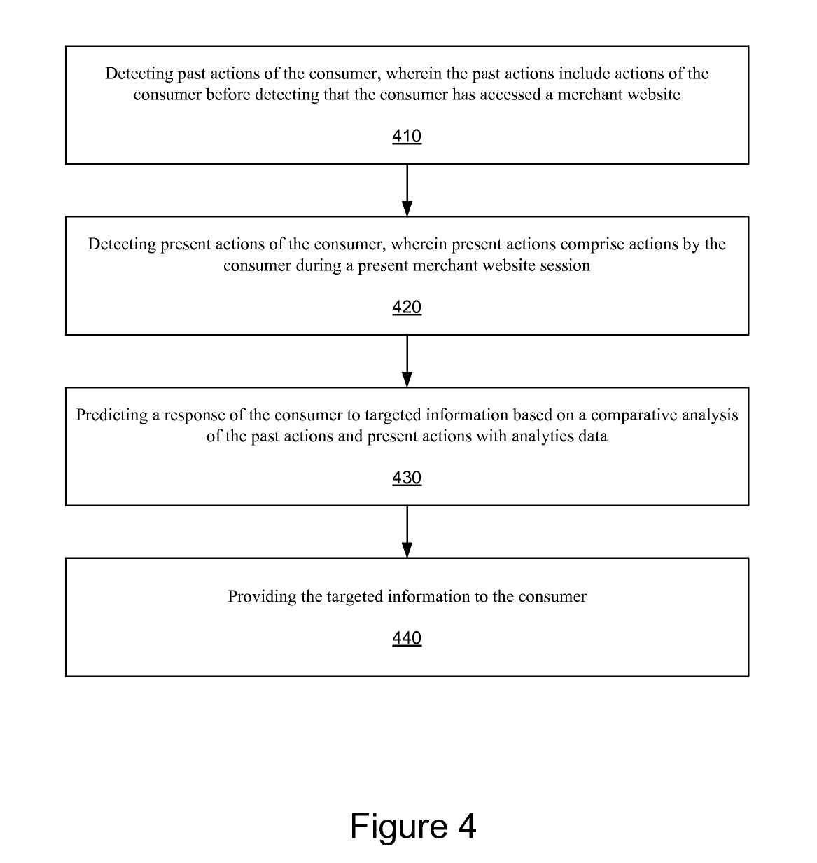

FIG. 4 is a flow chart that includes steps of a method of providing real-time targeted information to a consumer. A first step 410 includes detecting past actions of the consumer, where the past actions include actions of the consumer before detecting that the consumer has accessed a merchant application. A second step 420 includes detecting present actions of the consumer, where present actions include actions by the consumer during a present merchant application session. A third step 430 includes predicting a response of the consumer to targeted information based on a comparative analysis of the past actions and present actions with analytics data. A fourth step 440 includes providing the targeted information to the consumer.

In some embodiments, the analytic data is collected and analyzed. For example, as previously described, this can include collecting behavioral data of a plurality of users from a plurality of applications. The collected behavioral data is analyzed by clustering the collected behavioral data according to behavioral factors where collected behavioral data within each cluster comprise at least one common statistic, and collected behavioral data of different clusters have at least one differentiating statistic.

As previously mentioned, the providing of the targeted information to the consumer can be conditioned upon a determination that the consumer is attempting to leave the merchant application. In some embodiments, providing the targeted information to the consumer includes embedding and integrating the targeted information into the merchant's application.

As previously described, detecting past actions of the consumer can include determining past search terms used by the consumer, running a real-time search during the consumers present session, and determining competitive merchants based on search results of the real-time search. This can further include analyzing product information of the competitive merchants, and generating targeted information based on the analyzed product information.

In some embodiments, the comparative analysis includes generating a demand function for the consumer, where the demand function includes consumer characteristics, predetermined merchant rules, competitive information, and/or product type. Prices presented on the merchant's application can be managed based on the demand function. The demand function can be adaptively updated.

For example, a present user that views pages describing tennis rackets may be willing to purchase tennis balls at a price different from other users who had not viewed such pages. The demand function describes such willingness to buy products, at various prices, depending on the segment or factor a given user was matched to in the Consumer Behavioral Data.

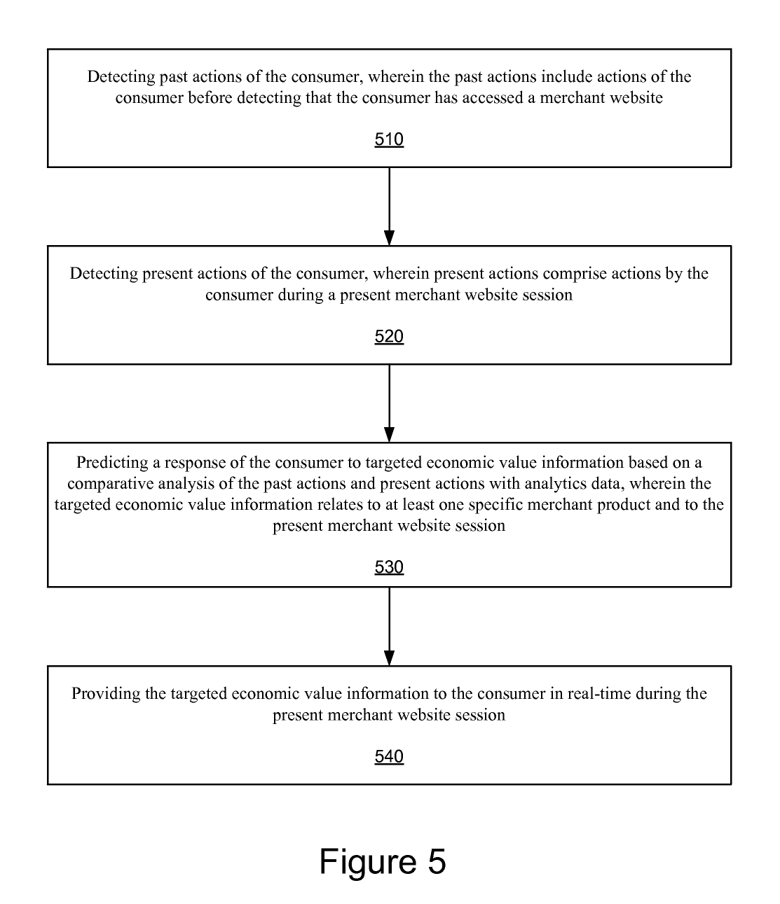

FIG. 5 is a flow chart that includes the steps of an example of a method of providing real-time targeted economic value information to a consumer. A first step 510 includes detecting past actions of the consumer, where the past actions include actions of the consumer before detecting that the consumer has accessed a merchant application. A second step 520 includes detecting present actions of the consumer, where present actions comprise actions by the consumer during a present merchant application session. A third step 530 includes predicting a response of the consumer to targeted economic value information based on a comparative analysis of the past actions and present actions with analytics data, where the targeted economic value information relates to at least one specific merchant product and to the present merchant application session. A fourth step 540 includes providing the targeted economic value information to the consumer in real-time during the present merchant application session.

In some embodiments, the targeted economic value information includes a specific offer of a price for a specific product. However, in some embodiments, the targeted economic value information includes things other than price. For example, an offer of free shipping or a two-for-one offer can additionally or alternatively be provided as examples of targeted economic value information. The targeted economic value information can be provided to the consumer in real-time during the present merchant application session. That is, the information is generated and displayed fast enough that the consumer visiting the merchant's application perceives the displayed information as “real-time.” That is, the consumer cannot observe a noticeable delay. The information is provided while the consumer is still on the merchant's application, and can be triggered, for example, by the consumer exiting a merchant application shopping cart, or attempting to leave the merchant's application without a purchase being completed.

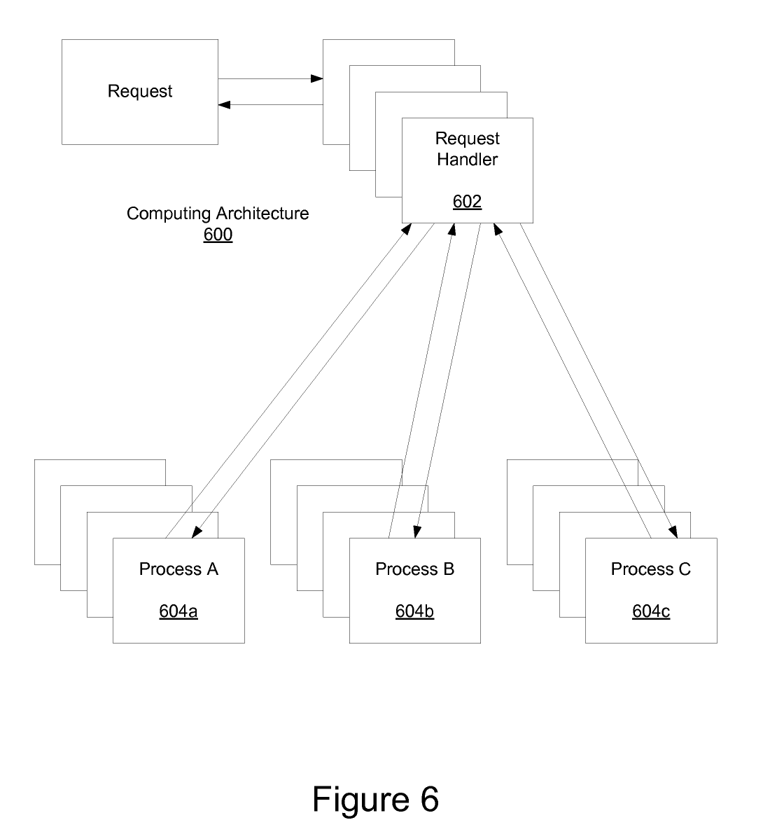

FIG. 6 shows a computing architecture in which the described embodiments can be implemented. In some embodiments, the prediction of the response of the consumer to targeted information is computed on a scalable computing architecture. In some embodiments, the scalable computing architecture includes swarm processing. The computer architecture of FIG. 6 can be particularly useful because it is a highly-scalable, parallel-processing architecture. The computing architecture 600 can be used for implementing the various functions previously described, such as behavioral data collection 132, behavioral data storage 142, clustering of behavioral data 152, clustered data storage 162, matching present user data with clustered behavioral data 232, and/or generating and targeting information 252.

In these embodiments, the computing architecture 600 comprises a request handler 602 and a multiple-processing framework and multiple concurrent processes 604 (604a, 604b, 604c), each such process representing a sub-task of a larger task that the architecture has been directed to complete. The computing architecture 600 can be implemented by a network of computers, such that the request handler 602 can assign any one or a multitude of the concurrent processes to any one or a multitude of networked computers (networked computers that can be communicated with by the computing architecture over available computer networks) for the completion of the task. Therefore, the overall capacity of the computing architecture to complete a task or a multitude of tasks within a certain elapsed time is only limited by the number of networked computers available. As the number of tasks grows, such as may occur by the addition of applications or visiting users, or the requirement for elapsed time to process a task decreases, or both, the computing architecture can successfully meet such requirements by adding additional networked computers, without limit.

For example, some embodiments include the simultaneous matching being handled by a request handler. The request handler receives multiple requests for matching and assigns any one or a multitude of the requests for matching to any one or a multitude of networked computers (networked computers that can be communicated with by the computing architecture over available computer networks) for the completion of the requests for matching. In some embodiments, clustering the collected behavioral data according to behavioral factors is handled by a request handler. The request handler receives multiple requests for clustering and assigns any one of a multitude of the requests for clustering to any one or a multitude of networked computers for the completion of the requests for clustering.

As a present user loads pages from the application that describe, for example, tennis rackets, contemporaneous to the load, a first server 132 executes the behavioral data collection of data describing the pages being loaded, while a second server 232 executes matching of present user data to one or more segments of clustered behavioral data. Some embodiments include the first and second servers employing the computing architecture 600 by accepting the task of matching the incoming data of the present user to segments in the Clustered Behavioral Data. In some embodiments, the task of matching is broken down into smaller sub-tasks that are assigned by the request handler 602 to various processes 604 (a, b, c). The request handler 602 subsequently assigns one or more processes 604 (a, b, c) to one or more networked computers. The assignment can be made for optimal speed of completion of each process 604. When all the processes 604 (a, b, c) are complete, the request handler 602 assembles the results of each sub-task from each corresponding processes 604 (a, b, c) into a complete result of the original task, namely that users who view tennis rackets are likely to buy tennis balls when offered a discount of a certain size.

In some embodiments, the request handler 602 includes Swarmiji, and the processes 604a, 604b, 604c include Sevaks. Only three Swarmiji Sevaks 604a, 604b, and 604c are shown for the purpose of illustration. Swarmiji Sevak is a Swarmiji worker process, and it can be easily spawned and coordinated to process real time or static data with a high degree of parallelism. Request handler 602 receives a request for a report or data from a requestor, such as a browser, a pricing engine, or a merchant. Thereafter, request handler 602 dispatches partial requests to Swarmiji Sevaks 604a, 604b, and 604c. Swarmiji Sevaks 604 a, 604b, and 604c complete partial requests and return the report to request handler 602. Request handler 602 then uses these reports to build a consolidated report and sends the report back to the requestor.

Swarmiji is a framework for creating and harnessing swarms of scalable concurrent processes called Swarmiji Sevaks. The framework is primarily written in Clojure on the Java Virtual Machine (JVM), which can utilize libraries from any JVM-compatible language. The framework draws heavily from existing systems such as Erlang, Termite, and the latest Nanite. The framework uses isolated processes to distribute computational load and pass messages to facilitate communication between processes. The framework also includes a management system that handles resource monitoring, process monitoring, etc.

Although specific embodiments have been described and illustrated, the embodiments are not to be limited to the specific forms or arrangements of parts so described and illustrated.

What is claimed is:

1. A computer-implemented method comprising:
compiling with a server coupled to a computer network behavioral data describing past actions including products viewed and purchases made by users while visiting applications hosted by servers accessible by the users via the computer network;
segmenting with the server the behavioral data into clusters of behavior factors according to statistically related actions of the users;
receiving by the server an electronic address for the user from a computer of the user;
processing with the server the electronic address for user data profiling the user;
computing with the server a match between the user data profiling the user and one of the clusters of behavior factors;
responsive to computing the match, generating with the server based on the match targeted information associated with a merchant application; and
providing by the server the targeted information to the computer of the user for presentation.

2. The computer-implemented method of claim 1, wherein processing the electronic address for user data profiling the user includes:
parsing with the server a business name from the email address; and
inferring with the server a business type from the business name.

3. The computer-implemented method of claim 2, further comprising:
processing with the server a log-in request received from the computer of the user;
determining with the server an IP address associated with the computer;
determining with the server a geographical location associated with the user using the IP address;
determining with the server a business location for the business name; and
confirming with the server the geographical location matches the business location.

4. The computer-implemented method of claim 2, wherein generating with the server based on the match targeted information associated with the merchant application includes:
identifying with the server one or more products related to the business type, the one or more products offered for sale via an application accessible via the computer network; and
including with the server the one or more products in the targeted information.

5. The computer-implemented method of claim 1, processing the electronic address for user data profiling the user includes applying natural language to the email address to determine the user data profiling the user.

6. The computer-implemented method of claim 1, wherein the electronic address is a business email address associated with the user.

7. The computer-implemented method of claim 1, further comprising:
delivering by the server coupled to the computer network the targeted information in an email to the user.

8. A computer-implemented method comprising:
compiling with a server coupled to a computer network behavioral data describing past actions including products viewed and purchases made by users while visiting applications hosted by servers accessible by the users via the computer network;
segmenting with the server the behavioral data into clusters of behavior factors according to statistically related actions of the user;
compiling with the server present user data describing a current action of a user while visiting a merchant application hosted by a server coupled to the computer network and accessible by the user;
computing with the server a match between the user data profiling the user and one of the clusters of behavior factors;
responsive to computing the match, generating with the server based on the match targeted information associated with a merchant application;
receiving an indication that the user has left the merchant application; and
retargeting with the server the user by transmitting the targeted information for display to the user as an advertisement via another application being used by the user.

9. The computer-implemented method of claim 8, wherein retargeting with the server the user includes:
receiving tracking information identifying the user's online location; and
providing the targeting information to an ad server associated with the online location for display to the user as the advertisement.

10. The computer-implemented method of claim 8, wherein retargeting with the server the user includes:
providing the targeting information to a web advertising exchange to present the targeted information to the user while the user is web browsing.

11. The computer-implemented method of claim 8, wherein
compiling with the server the behavioral data includes receiving with the server user click-through data describing click-throughs performed by the user while viewing content via the applications hosted by the servers, and
retargeting with the server the user includes determining with the server information included within the content viewed and influencing with the server the targeted information based on one or more of the click-throughs and the content viewed.

12. A system comprising:
one or more processors; and
one or more memories storing instructions that, when executed by the one or more processors, cause the system to:
compile behavioral data describing past actions including products viewed and purchases made by users while visiting applications;
segment the behavioral data into clusters of behavior factors according to statistically related actions of the user;
receive an electronic address for the user from a computer of the user;
process the electronic address for user data profiling the user;
compute a match between the user data profiling the user and one of the clusters of behavior factors;
responsive to computing the match, generate based on the match targeted information associated with a merchant application; and
provide the targeted information to the computer of the user for presentation.

13. The system of claim 12, wherein processing the electronic address for user data profiling the user includes:
parsing a business name from the email address, and
inferring a business type from the business name.

14. The system of claim 13, wherein the instructions, when executed by the one or more processors, further cause the system to:
process a log-in request received from the computer of the user;
determine an IP address associated with the computer;
determine a geographical location associated with the user using the IP address;
determine a business location for the business name; and
confirm the geographical location matches the business location.

15. The system of claim 13, wherein to generate based on the match targeted information associated with the merchant application includes:
identifying one or more products related to the business type, the one or more products offered for sale via an application accessible via the computer network, and
including the one or more products in the targeted information.

16. The system of claim 12, processing the electronic address for user data profiling the user includes applying natural language to the email address to determine the user data profiling the user.

17. The system of claim 12, wherein the electronic address is a business email address associated with the user.

18. The system of claim 12, wherein the instructions, when executed by the one or more processors, further cause the system to:
deliver the targeted information in an email to the user.

19. A system comprising:
one or more processors;
one or more memories storing instructions that, when executed by the one or more processors, cause the system to:
compile behavioral data describing past actions including products viewed and purchases made by users while visiting applications;
segment the behavioral data into clusters of behavior factors according to statistically related actions of the user;
compile present user data describing a current action of a user while visiting a merchant application;
compute a match between the user data profiling the user and one of the clusters of behavior factors;
responsive to computing the match, generate based on the match targeted information associated with a merchant application;
receive an indication that the user has left the merchant application; and
retarget the user by transmitting the targeted information for display to the user as an advertisement via another application being used by the user.

20. The system of claim 19, wherein to retarget the user includes:
receiving tracking information identifying the user's online location; and
providing the targeting information to an ad server associated with the online location for display to the user as the advertisement.

21. The system of claim 19, wherein to retarget the user includes:
providing the targeting information to a web advertising exchange to present the targeted information to the user while the user is web browsing.

22. The system of claim 19, wherein
compiling the behavioral data includes receiving with user click-through data describing click-throughs performed by the user while viewing content via the applications, and
retargeting the user includes determining information included within the content viewed and influencing the targeted information based on one or more of the click-throughs and the content viewed.
